(19) United States
(12) Patent Application Publication
(10) Pub. No.: US 2012/0117188 A1
(43) Pub. Date: May 10, 2012

(54) METHODS AND SYSTEMS FOR COORDINATING YOUTH AND FAMILY SERVICES REFERRALS

(75) Inventors: William Monroe Nidiffer, Henderson, NV (US); Eric Monroe Nidiffer, Henderson, NV (US)

(73) Assignee: YOUTH CHOICES, LLC, Las Vegas, NV (US)

(21) Appl. No.: 13/289,269

(22) Filed: Nov. 4, 2011

Related U.S. Application Data
(60) Provisional application No. 61/410,067, filed on Nov. 4, 2010.

(51) Int. Cl. G06F 15/16

(52) U.S. Cl. 709/217

(57) ABSTRACT

Methods and systems for coordinating the referrals of youth and family services are provided. The methods and systems include a repository of community service organizations that are matched with an at-risk youth, parent, or other individual based on the risk factors associated with the subject and the interests of the subject. A mentor may be assigned to the subject to facilitate participation with the service organization. Follow-up is conducted by the method and system to increase the effectiveness of the treatment programs referred thereby.

### CROSS REFERENCE TO RELATED APPLICATIONS

This application claims priority to U.S. Provisional Patent Application Ser. No. 61/410067, filed Nov. 4, 2010, the contents of which are hereby incorporated by reference.

### BACKGROUND OF THE INVENTION

This invention relates generally to positive youth and family development and, more particularly, to network-based methods and systems for coordinating youth and family services referrals.

A significant percentage of today's youth are considered to be “at-risk” of failing to become positive contributors to society. The sources of these risks are varied. For example, today's youth are confronted with destructive issues including drugs, alcohol, gangs, depression, diminished self-esteem, suicide, and premature sexual activity, among others. A commonality in at least some of these at-risk youth situations is that such at-risk youths are not exposed to a sufficient number of positive role models, and their lives do not regularly expose them to resources that help them to develop their positive assets and enable them to achieve their full potential. In at least some of these known at-risk situations, the at-risk youths do not develop into contributors to the improvement of their community.

There are many service organizations (e.g., civic, faith-based, charitable) that attempt to provide positive influences to at-risk youths and their families within the community in which these organizations are based. However, these organizations are often over-burdened and unable to coordinate their services with other organizations within the community. Many youths and families are introduced to these organizations via referrals from courts and/or other organizations. Because the referrer is often unaware of the current capacity and/or capabilities of the various organizations, participants may not be timely referred to an organization that is capable of assisting specific participants with specific issues. For example, a juvenile offender may wait in jail for months while a judge contacts various organizations to determine where the juvenile should be referred.

In addition, after a participant is referred to a particular organization, it may be difficult to monitor attendance or involvement with the particular organization. Continuing the example above, the judge may not be able to determine whether the juvenile offender has been attending classes at the referred organization.

Accordingly, it would be desirable to provide a computer system for providing referral information, monitoring treatment, and sharing information among treatment organizations.

### BRIEF DESCRIPTION OF THE INVENTION

In one embodiment, a computer-implemented method including executing instructions stored on a computer-readable medium is provided. The method includes receiving identification information of a subject, receiving profile information about the subject, determining, via a processor, at least one service organization based on the identification information and the profile information, and transmitting information about the at least one service organization.

In another embodiment, a computer-readable medium having computer-executable instructions embodied thereon is provided. The computer-executable instructions are executed on a computing device. The instructions instruct the computing device to receive identification information of a subject, receive profile information about the subject, determine, via a processor, at least one service organization based on the identification information and the profile information, and transmit information about the at least one service organization.

In another embodiment, a computer system including instructions stored on a computer-readable medium and executable by at least one processor is provided. The computer system includes an identification manager configured to receive a subject identifier of a subject and a profile information about the subject, a service organization manager configured to determine, using the at least one processor, at least one service organization based on the subject identifier and the profile information, and an activity manager configured to transmit information about the at least one service organization.

### BRIEF DESCRIPTION OF THE DRAWINGS

FIGS. 1-4 show exemplary embodiments of the methods and systems described herein.

FIG. 1 is a simplified block diagram of an exemplary system for providing service organization referrals.

FIG. 2 is a simplified block diagram of a mobile system that may be used with the system of FIG. 1.

FIG. 3 is a flowchart illustrating an exemplary operation of the system of FIG. 1.

FIG. 4 is a block diagram showing example or representative computing devices and associated elements that may be used to implement the systems and methods of FIGS. 1-3.

### DETAILED DESCRIPTION OF THE INVENTION

Embodiments of the methods and systems described herein enable a community to coordinate and monitor (i) youth service providers encountering at-risk youth, (ii) youth fostering programs, (iii) treatment of parents, (iv) government-approved resources and mentors, (v) referral assistance from approved local resources; (vi) ongoing accountability and follow-up progress reporting, and (vii) the gathering and reporting of youth program statistics, including program attendance.

The following detailed description illustrates embodiments of the invention by way of example and not by way of limitation. It is contemplated that the invention has general application to coordinating youth and family services referrals within a variety of geographic and jurisdictional areas with youth, parents, foster parents, law enforcement, case workers, teachers, school administrators, counselors, nurses, doctors, pastors, firemen, social workers, mentors, diversionary programs, skill-building programs, treatment programs, government organizations (e.g., agencies, courts, correctional facilities), schools, and other service organizations (e.g., civic, faith-based, charitable), among others.

By way of example, and not limitation, the methods and systems described herein may be used to identify a service organization and a mentor that may provide assistance to an at-risk youth. Again, it is contemplated that these same methods and systems may be used with foster children, parents, family members, or any person or persons. As a specific example, a police officer may encounter the at-risk youth at the youth's home. Using a handheld device that implements the methods and systems described herein, the police officer may collect identifying information about the youth, such as a name, address, languages spoken, and birthdate. The police officer may also identify several risk factors associated with the youth, such as the presence of gang paraphernalia and abusive parents. The police officer may also identify one or more of the youth's interests, such as basketball or astronomy. Having collected and input the identifying information and the profile information, including risk factors and interests, into the handheld device, the police officer submits the collected information to a centralized computer system.

Continuing the example above, the computer system may receive the information about the subject, determine at least one service organization that can help the youth, and transmit that information back to the police officer while the police officer is still with the youth. The computer system contains information about various service organizations, such as which ages and genders the organization services, which interests, activities, and languages the organization may handle, current capacity for new referrals, hours and location. Using the information about the youth in combination with the information about the service organizations, the computer system may provide a list of one or more service organizations to the police officer on his handheld device. Generally speaking, the list provided by the computer system may include the best matches of, or the most appropriate, service organizations for the youth based on available information. The police officer may then select from a list of possible service organizations the organization that is closest to the youth, is best situated to handle the youth's risk factors or interests, or is otherwise best suited to service the youth. After the police officer selects an organization using the handheld device, the handheld device may transmit selection information to the computer system. More particularly, the police officer may schedule a particular day of the week and time for the youth to visit the service organization. The computer system may then store the selection information such that an affiliation is made between the youth and the service organization. The youth identification and profile information may also be stored by the computer system.

Continuing in the example above, the computer system may also store information about youth mentors. A mentor may be a pastor or a volunteer that has been identified as someone who can help at-risk youth to participate with assigned service organizations and to otherwise assist the youth in benefiting from the methods and systems described herein. For example, a mentor might follow up with a youth to verify that the youth attended school or visited the service organization on schedule. The mentor may simply make sure that the youth has transportation to the service organization. When the police officer selects a service organization, the computer system may assign a youth mentor to the youth. Alternatively, similar mentoring services may be provided by the methods and systems described herein.

Continuing the example above, the computer system may communicate information about the police officer's encounter with the youth to the other parties involved. More specifically, the computer system may notify the assigned service organization and the assigned mentor that the at-risk youth has been assigned to them and, if applicable, that a specific schedule of attendance has been given to the youth. Communication is further facilitated by the computer system by requesting updates from the parties involved (i.e., the police officer, the service organization, and the mentor) and by providing activity reports to the parties involved. For example, the service organization may receive an email from the computer system asking whether the youth visited the service organization as scheduled. Alternatively, the service organization may report the youth's attendance without receiving a request. The service organization may provide to the computer system, via a web interface, a report indicating that the youth did not visit the organization as planned. The computer system may transmit a notification to the police officer and the mentor indicating that the youth failed to keep an appointment, prompting the police officer and/or the mentor to follow up with the youth.

In another example, an at-risk youth and/or parent may be in front of a judge who wishes to assign the youth and/or parent to an appropriate service organization. Using a web interface, the judge may input information about the youth and/or parent and make a referral within minutes. Without the methods and systems described herein, the judge may have to detain the youth and/or parent until a referral can be made. The methods and systems described herein enable the judge to know, in real-time, which organizations are suitable for the youth and/or parent and which have sufficient capacity. Additionally, the judge may receive updates from the assigned service organization, via the computer system, indicating whether the youth and/or parent are compliant with the court's orders. As illustrated by these examples, which, again, are provided by way of example and not limitation, the methods and systems described herein provide an efficient and cost-effective solution to the problems of uncoordinated referrals, as described more fully herein.

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

The methods and systems described herein may be implemented using computer programming or engineering techniques including computer software, firmware, hardware or any combination or subset thereof, wherein the technical effects may include at least one of: a) receiving identification information of a subject; b) receiving profile information about the subject; c) determining at least one service organization based on the identification information and the profile information; and d) transmitting information about the at least one service organization.

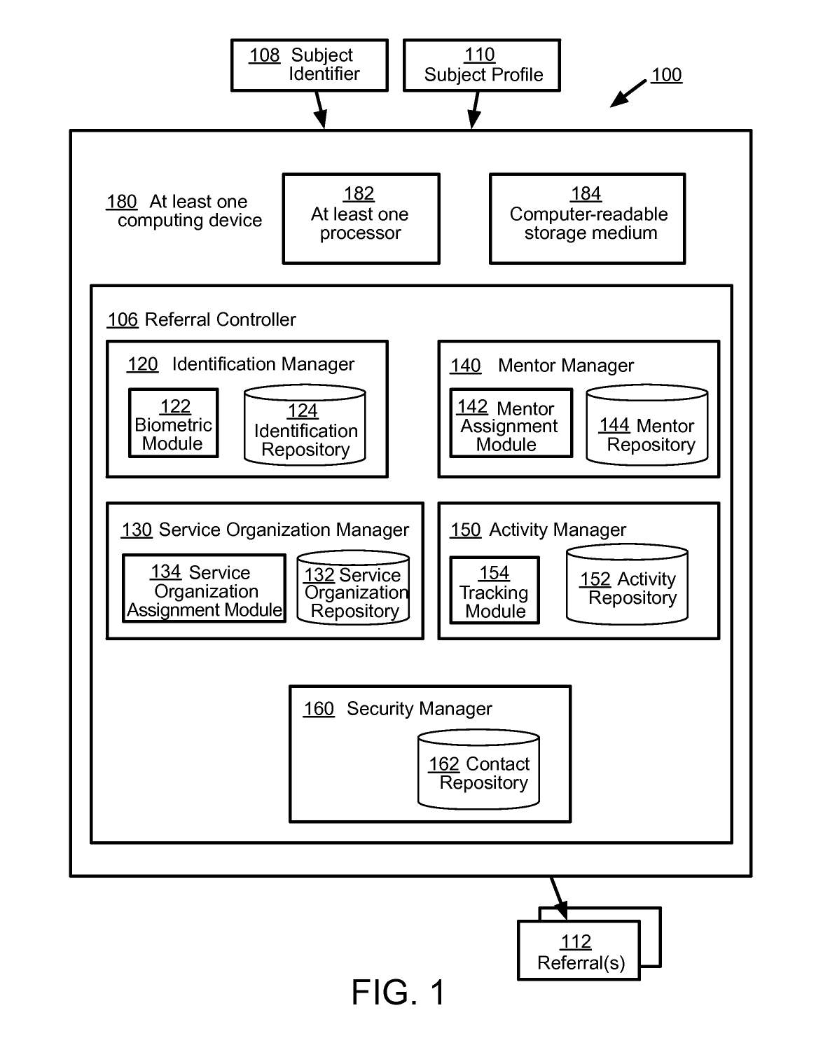

FIG. 1 is a simplified block diagram of an exemplary system 100 for providing service organization referrals. In the example of FIG. 1, a referral controller 106 is configured to receive a subject identifier 108 and a subject profile 110 from a user of system 100, and to output at least one referral 112. The subject identifier 108 may include any information that may be used to identify a subject, such as, but not limited to, a name, address, birth date, social security number, case number, phone number, driver license number, biometric information, and/or any combination thereof The subject profile 110 may include information, such as risk factors and interests, about the subject that enable the referral controller 106 to determine a suitable service organization for the subject. Risk factors may include facts and circumstances about the subject, including, but not limited to, aggression, anti-social behavior, difficulty concentrating, exposure to violence, history of running away, low self-esteem, physical violence, rebelliousness, anger management issues, dishonesty, hyperactivity, substance abuse, abusive parents, broken home, gang history, and/or any other factor now known or discovered in the future which may indicate the existence of negative behaviors and/or the propensity for negative behaviors, and/or may be identified by a service organization as a fact or circumstance for which the service organization provides treatment. Interests may include any interest or hobby of the subject, such as, without limitation, baseball or painting.

In the exemplary embodiment, and as explained in more detail herein, the referral controller 106 may include an identification manager 120, which may be configured to receive the subject identifier 108. The identification manager 120 may include a biometric module 122 and an identification repository 124. The biometric module 122 may be configured to analyze biometric information, which may be contained in the subject identifier 108. The identification repository 124 may be configured to process and store both new and existing subject identifiers 108. The identification repository 124 may be configured to store the subject profile 110 such that it is affiliated with the subject identifier 108.

The referral controller 106 may include a service organization manager 130 that is configured to store information about available service organizations in a service organization repository 132. The service organization manager 130 may include a service organization assignment module 134 that is configured to provide service organization information based on the subject identifier 108 and/or the subject profile 110. The service organization manager 130 may be configured to store service organization assignment information, such as the identity of the service organization assigned to the subject, in the service organization repository 132.

The referral controller 106 may include a mentor manager 140 that is configured to store information about available mentors in a mentor repository 142. The mentor manager 140 may include a mentor assignment module 144 that is configured to match mentors to subjects based on the subject identifier 108 and/or the subject profile 110. The mentor manager 140 may be configured to store mentor assignment information, such as the identity of the mentor assigned to the subject, in the mentor repository 142.

The referral controller 106 may include an activity manager 150 that is configured to track and report the progress of the subject by collecting, storing, and sharing information such as attendance at the service organization, contact with the mentor, attendance at school, parole/probation order compliance, and the like. The activity manager 150 may include an activity repository 152 that is configured to store and retrieve the collected activities of the subject.

The activity manager 150 may include a tracking module 154 that is configured to solicit and/or collect information about the subject's activities. Because the referral controller 106 may collect and/or contain information about youth subjects, medical information, juvenile court cases, sensitive information, personally identifiable information, and other restricted information, the referral controller 106 may include a security manager 160 that is configured to implement privacy and security policies to facilitate compliance with relevant laws and regulations. More specifically, the security manager 160 may include a contact repository 162 that stores information about non-subject users of the system 100, including, but not limited to, parents, parole/probation officers, case workers, judges, governmental agencies, schools, and the like, including contact information and security level. The contact repository 162 may also be configured to store security levels for any person or entity able to receive information from the referral controller 106, such as the service organization and the mentor. The contact repository 162 may also store the privacy and security policies to be enforced by the security manager 160.

The referral(s) 112 may include information about either or both of the assigned service organization from the service organization manager 130 and the assigned mentor from the mentor manager 140. The referral controller 106 may be configured to transmit the referral 112 to the user, whether remote or otherwise, of the system 100. Alternatively, or additionally, the referral 112 may contain information about the subject and be transmitted to the assigned service organization and/or mentor. Other features and advantages of the system 100 illustrated in FIG. 1 are described in more detail herein.

In the example of FIG. 1, the referral controller 106 is illustrated as executing on at least one computing device 180, which may include or be associated with at least one processor 182 and a computer-readable storage medium 184. Again, however, it may be appreciated that many various configurations of the system 100 may be implemented beyond the examples illustrated and described with respect to FIG. 1. References to receiving or transmitting may be understood to include any method or system now known or discovered in the future for moving data, signals, and/or information between systems and/or components of a single system.

For example, it may occur that different elements of the referral controller 106 are executed using different computing devices (e.g., a remote computer and a local computer which are connected by a particular network). In other examples, elements and components of the system 100 which are illustrated singularly may be implemented using two or more separate subcomponents. Conversely, elements and components illustrated separately from one another may be executed within a single module. These and other configurations of the system 100 may be understood to represent matters of design choice that would be apparent to one of skill in the art, and therefore are not discussed herein in further detail, except as may be necessary or helpful in understanding operations of the system 100 of FIG. 1.

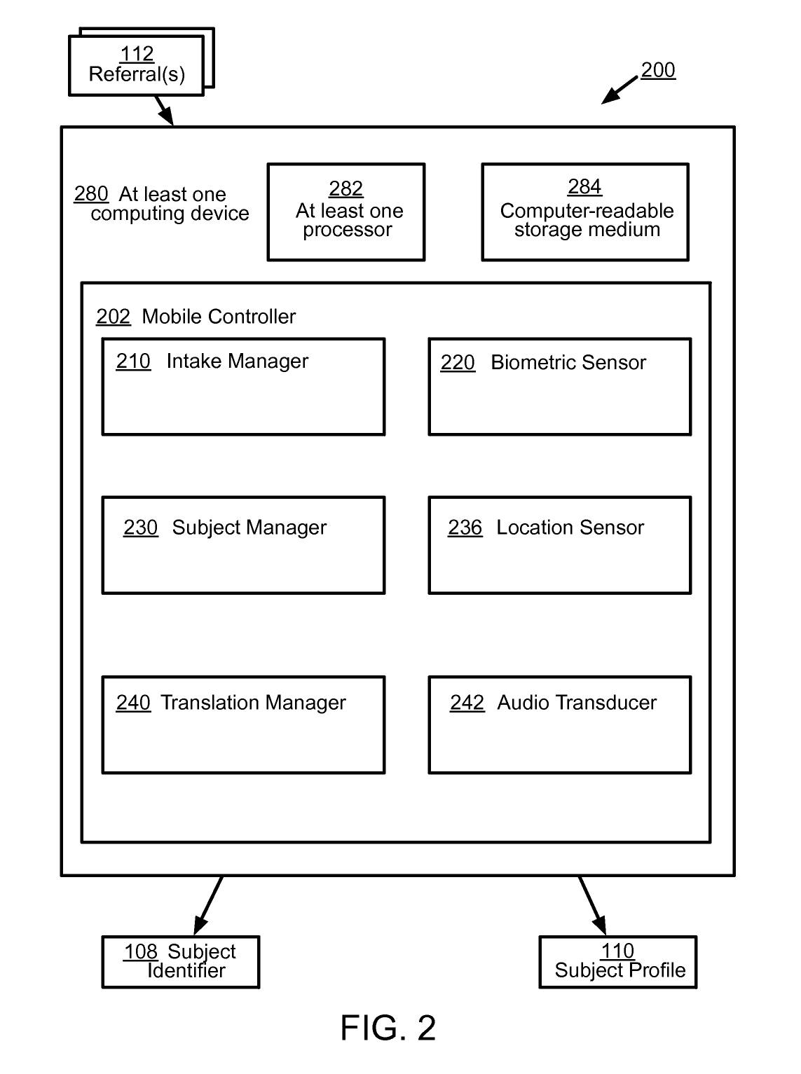

FIG. 2 is a simplified block diagram of a mobile system 200 that may be used with the system 100 of FIG. 1. Similar components have been given the same reference characters in both FIGS. 1 and 2. In the example of FIG. 2, the mobile system 200 may include a mobile controller 202 that is configured to facilitate subject intake, subject communication, mentor communication, and/or other functionality described in more detail herein. For example, the mobile controller 202 may include an intake manager 210 that is configured to collect the subject identifier 108 and/or the subject profile 110 and receive one or more referrals 112. A user of the mobile system 200 may input, e.g., using a graphical user interface (GUI), information about a subject including the subject identifier 108 and the subject profile 110. The mobile system 200 may transmit the subject identifier 108 and the subject profile 110 to the system 100 of FIG. 1 for processing. The mobile system 200 may receive from the system 100 of FIG. 1 one or more referrals 112 and may, using the GUI, display the referrals 112 to the user of mobile system 200. Alternatively, or additionally, the user of mobile system 200 may collect biometric information about the subject using a biometric sensor 220 included in mobile system 200. The biometric information may be included with the subject identifier 108.

The mobile controller 202 may include a subject manager 230 that is configured to collect and transmit information about the subject and/or communicate with the subject. For example, the mobile system 200 may include a location sensor 236, which is used by the subject manager 230 to transmit the subject's location (i.e., the location of the mobile system 200) to the system 100 of FIG. 1. The subject manager 230 may communicate with the user of the mobile system 200, who may be a subject, to facilitate participation of the subject in assigned programs. For example, the subject manager 230 may provide a calendar of events, automated surveys, courses on behavioral issues, case plan or court order instructions, daily positive texts, reminders of appointments, chat/text/call/usage monitoring, transportation coordination, phone use reports, an emergency help button, and/or other functions as described in more detail herein. It should be appreciated that the subject manager 230 may replace or supplement a human mentor assigned to the youth. In other words, the subject manager 230 may be seen as a virtual mentor capable of providing virtual treatment and mentorship.

The mobile system 200 may include at least one audio transducer 240 that is configured to receive and transmit audio signals, including vocal sounds. The mobile controller 200 may include a translation manager 242 that is configured to receive spoken language audio from the transducer 240 in a first language and produce spoken language audio using the transducer 240 in a second language. Other features and advantages of the mobile system 200 illustrated in FIG. 2 are described in more detail herein.

In the example of FIG. 2, the mobile controller 202 is illustrated as executing on at least one computing device 280, which may include or be associated with at least one processor 282 and a computer readable storage medium 284. Again, however, it may be appreciated that many various configurations of the mobile system 200 may be implemented beyond the examples illustrated and described with respect to FIG. 2.

For example, it may occur that different elements of the mobile controller 202 are executed using different computing devices (e.g., a remote computer and a local computer which are connected by a particular network). In other examples, elements and components of mobile system 200 which are illustrated singularly may be implemented using two or more separate subcomponents. Conversely, elements and components illustrated separately from one another may be executed within a single module. These and other configurations of the mobile system 200 may be understood to represent matters of design choice that would be apparent to one of skill in the art, and therefore are not discussed herein in further detail, except as may be necessary or helpful in understanding operations of the mobile system 200 of FIG. 2.

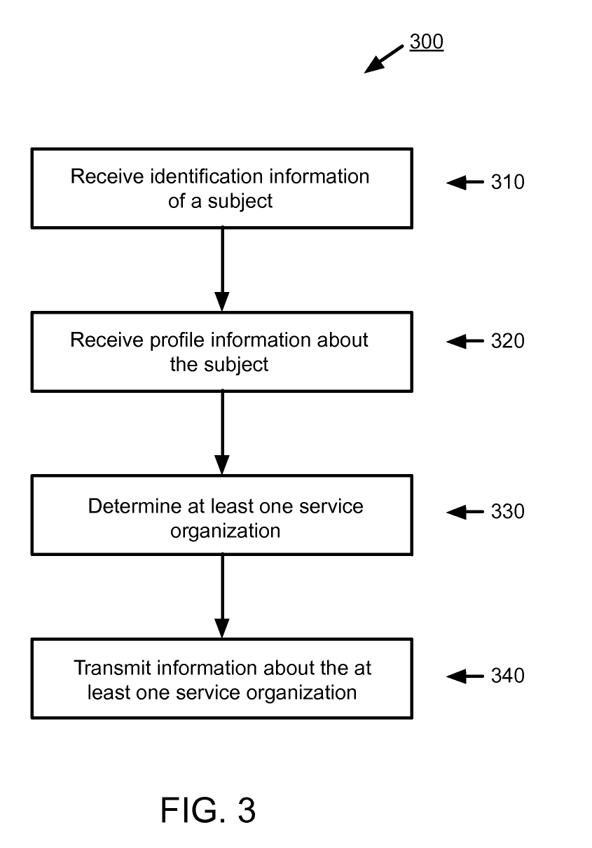

FIG. 3 is a flowchart 300 illustrating example operations of the system 100 of FIG. 1. In the example of FIG. 3, operations 310-340 are illustrated in sequential order. However, it may be appreciated that the flowchart 300 illustrates non-limiting examples of operations of the system 100 of FIG. 1. For example, two or more operations of the operations 310-340 may be executed in a partially or completely overlapping or parallel manner. In other examples, operations may be performed in a different order than that shown. Further, additional or alternative operations may be included.

In the example of FIG. 3, identification information about a subject may be received 310. The identification information, as described herein, may include a name, an address, a birthdate, and/or biometric information such as a picture, voice recording, fingerprint, or the like. Profile information about the subject may also be received 320. The profile information, as described herein, may include known risk factors such as school status, criminal history, and/or family characteristics. Risk factors may include any

Based on the identification information and the profile information, at least one service organization may be determined 330. Service organizations, as described herein, may include, without limitation, any religious, civic, charitable, not-for-profit group, for-profit group, church, program, school, institution, and/or sponsorship that services youth, parents and/or families for the purpose of improving their current and/or future education, job prospects, health, attitude, criminal history, chances of being reunited, or general impact on the community.

Information about the at least one service organization may be transmitted 340. More specifically, information about the at least one service organization may be transmitted 340 or output to a user of the system 100, to a user of the mobile system 200, to the system 100, to the mobile system 200, to a remote computing device, and/or any other system or person which enables the system 100 to function as described herein. Information about the at least one service organization may include names, phone numbers, locations, capacities, hours of operation, specific event schedules, and/or general information about the programs available from the service organization, among other things. More specifically, information about the at least one service organization may include specific days and times when the subject is scheduled to visit the service organization.

A more detailed example of the operation of the methods and systems described herein is provided wherein it is desired that an at-risk youth be referred to a service organization that can cater to the needs and interests of the youth. While reference is made throughout to at-risk youth, it is contemplated that the methods and systems described herein may be used to assist a wide variety of subjects with no limitation on age or risk status, including, without limitation, family members of at-risk youth, foster children, parents generally, and any other person or persons.

Considering FIGS. 1-3 together, and continuing the example above, a police officer may encounter the at-risk youth, who is demonstrating destructive issues, such as aggression for the purposes of this example. The community in which the police officer and the youth reside has already implemented the methods and systems described herein. Accordingly, when the police officer encounters the youth, the youth may already be registered with, or known to, such systems. However, for the purposes of this example, the youth is not yet registered.

Continuing the example above, the police officer may encounter the youth at school, after the youth has been caught fighting with classmates. Armed with the mobile system 200 of FIG. 2, which may be a mobile phone, laptop, tablet, specialized hardware or similar, the police officer begins by collecting biographical information about the youth, such as a name, address, and date of birth. The police officer may input this information into the mobile system 200 using the intake manager 210, and such information may constitute the subject identifier 108. Alternatively, or additionally, the police officer may collect biometric information about the youth using the biometric sensor 220, such as a picture, fingerprint, and/or voice recording, which may become part of the subject identifier 108.

The subject identifier 108 is transmitted by the intake manager 210 of the mobile system 200 to the identification manager 120 of the system 100 using known techniques for securely transmitting data. For example, the intake manager 210 may use the HTTPS protocol to communicate with a web-based interface of the identification manager 120. After receiving 310 the subject identifier 108, the identification manager 120 compares the subject identifier 108 with known subjects in the identification repository 124. If biometric information is included with the subject identifier 108, the biometric module 122 may process the biometric information to facilitate comparison with biometric information stored in the identification repository 124. In this example, the identification manager 120 may identify several youth in the identification repository 124 who are similar to the encountered youth. The several youth identified by the identification manager 120 may be transmitted to the intake manager 210.

The police officer may then decide if the encountered youth is already represented in the identification repository 124. If the police officer determines that the youth is already in the identification repository 124, the police officer may update/edit the identification information in the identification repository 124 for the encountered youth. Otherwise, the police officer may proceed to input/register the encountered youth with the identification repository 124. It should be appreciated that the identifier information 108 collected in an initial intake may be used subsequently to identify known subjects. Accordingly, the subject identifier 108 provided by the police officer may be stored in identification repository 124.

The police officer may thereafter input, using the intake manager 210, profile information 110 about the youth. The intake manager 210 may present a list of known risk factors for negative behavior and the police officer may provide an indication of which risk factors apply. In addition, or alternatively, the intake manager 210 may collect from the police officer the interests or hobbies of the youth, perhaps as expressed by the youth in an interview with the police officer. For example, the police officer may indicate that the youth uses drugs, is often truant, and likes boxing. The intake manager 210 transmits the profile information 110 to the service organization manager 130, where it is received 320.

Continuing in the example above wherein the subject is an at-risk youth, the system 100 may have stored therein the names, addresses, operating hours, activities, special programs, and capacities, among other things, of one or more services organizations. Without limiting the generality of the foregoing, the system 100 may have stored, within the service organization repository 132, information about a charitable organization that teaches boxing to young men two times per week. Accordingly, and assuming that the youth used in this example is a male, the service organization manager 130 may determine, using the service organization assignment module 134 and based on the subject identifier 108 and the subject profile 110, that the charitable organization that teaches boxing is appropriate for the encountered youth. The service organization assignment module 134 may determine 330 appropriate service organizations using a number of factors, including whether the service organization has sufficient capacity, how close the service organization is to the subject's home, whether the service organization offers the hobbies/interests/languages of the subject, and/or other factors consistent with the teachings found herein.

The service organization manager 130 may transmit 340 information about one or more service organizations, i.e., the referrals 112, to the intake manager 210 for presentation to the user of mobile system 200. Continuing the example above, the police officer may be presented, e.g., using a GUI, with the referrals 112 determined by the service organization manager 130 to be appropriate for the encountered youth. The police officer may select one or more service organizations from the presented list of referrals using the intake manager 210. For example, the intake manager 210 may indicate how far each service organization is from the youth's home, and the police officer may select from the organizations closest to the youth's home. The intake manager 210 may transmit this selection to the service organization assignment module 134 in order to assign/refer the subject to the selected service organization. Alternatively, more than one service organization may be selected. The service organization assignment module 134 may confirm that the referral was successful to the intake manager 210. Assignment may be accomplished by storing the assignment, or referral, of the subject to the service organization in the service organization repository 143. Such an assignment/referral may include specific days of the week, dates, and/or times when the subject is required to visit the service organization.

Continuing the example above, before the youth is referred to a service organization, the police officer may present the list of service organizations to a parent of the youth. The parent may indicate consent to the assignment and participation in other treatments by, for example, providing a signature using the mobile system 200.

In order to increase the likelihood that the subject will participate with the assigned service organization, a mentor, or more than one mentor, may be assigned to the youth. Continuing the example above, the mentor manager 140 may determine, using the mentor assignment module 144 and based on the subject identifier 108 and the subject profile 110, a suitable mentor for the encountered youth. A suitable mentor may be a mentor who has capacity to take a new mentee, has the same gender, has experience with the risk factors exhibited by the subject, shares an interest/hobby with the subject, and/or has experience with any other factor/item contained in the subject identifier 108 or the subject profile 110. Similar to the process of assigning a service organization, the information for one or more mentors may be transmitted by the mentor manager 140 to the intake manager 210 for review and selection by the user of the mobile system 200. Alternatively, the mentor may be assigned without any input from the user of the mobile system 200. Parental consent may be collected by the intake manager 210 for the assignment of a mentor.

One of the benefits of a centralized system for providing referrals to service organizations is that all of the parties involved, or all interested parties or stakeholders, may provide and receive updates on the progress of the subject. Continuing the example above, the activity manager 150 may be notified of the referral/assignment of the youth to a particular service organization and/or mentor. More specifically, the service organization manager 130 may notify the activity manager 150 that an activity has occurred regarding the youth. The activity manager 150 may store the activity (i.e., the referral) in the activity repository 152.

The tracking module 154 within the activity manager 150 may be configured to send out activity alerts and/or solicit updates on subjects. Continuing the example above in which the youth has been referred to a service organization and a mentor, the tracking module 154 may transmit an alert to both the service organization and the mentor indicating that the youth has been referred to that particular service organization and mentor.

The contents and the recipients of alerts and other communications from referral controller 106 may be controlled by the security manager 160. In the example above, an alert regarding the referral of the youth may also be sent to the principal of the youth's school, the youth's parents, and/or the youth's parole/probation officer, as applicable. The security manager 160 is configured to comply with known laws and regulations, and, accordingly, the foregoing alert will only be sent to each of the exemplary recipients if the dissemination of the information in the alert to that recipient is permissible, either by law, regulation, or consent (i.e., according to pre-determined privacy/security policies).

The tracking module 154 may also solicit feedback from either the subject or the other users of system 100. In the example above, the tracking module 154 may, following a scheduled visit of the youth to the service organization, solicit feedback whether the youth attended as scheduled from either or both of the assigned service organization and the assigned mentor. It should be appreciated that such solicitations of feedback, or transmittal of alerts as above, may be accomplished using known means for communicating with users of local or remote systems. For example, the system 100 may include a web interface and messages may be displayed using the web interface. Alternatively, messages may be sent by email or by using the mobile controller 202.

Continuing the example above, the service organization may indicate to the tracking module 154 that the youth did not visit the service organization as scheduled. The activity manager 150 may log the youth's absence in the activity repository 152. The activity manager 150 may cause the tracking module 154 to transmit an alert to the interested parties via the security manager 160. More particularly, the security manager 160 may retrieve a list of interested parties from the contact repository 162 and transmit the alert to the interested parties where such a transmittal would be compliant with the privacy restrictions embodied in the security manager 160. Interested parties may include any contact that is interested in or entitled to information about a particular subject. In the example above, interested parties may include the service organization, the mentor, the school principal, the police officer, and/or the parents.

Alternatively, in the foregoing example, any of the interested parties may cause alerts to be sent to the other interested parties. For example, the principal may, via the activity manager 150, report that the youth was absent from school. Accordingly, truancy may be logged in the activity repository 152, and an alert may be sent via the security manager 160.

It should be appreciated that meaningful reports may be generated from all of the data stored within referral controller 106. Access to any information within referral controller 106 may be selectively controlled by the security manager 160. For example, security levels may be established within the contact repository 162. Continuing in the example above, the school principal may be given a security level sufficient that the school principal may receive alerts and view information for students at the principal's school, but not another school. As another example, a mental health professional who is a contact affiliated with the youth may be able to view health related information of the youth, but the school principal is not. As yet another example, a judge overseeing, or a government agency taking the lead on, a juvenile case involving the youth may be able to view all information contained within referral controller 106 pertaining to the youth.

The security manager 160 may also control the information that is shared via alerts and reports. For example, two agencies may have information about the encountered youth, but the two agencies are restricted from sharing that information. Consequently, the security manager 160 may limit the information that is shared between the two agencies. However, the security manager 160 may be configured to alert a first agency that follow-up with the subject is required if a second agency notifies the activity manager 150 that an event has occurred.

It should further be appreciated that all information contained within, and transmitted to/from, referral controller 106 may be encrypted or otherwise obfuscated to prevent unauthorized access.

Continuing the example above, the youth may be given a computing device that implements the mobile system 200 of FIG. 2. For example, the youth may be given a smart phone with the software, firmware, and/or, hardware configured as illustrated in FIG. 2. Alternatively, or additionally, a parent, mentor, case worker, and/or other interested party may have and use the mobile system 200. The system 100 may communicate with the youth using the subject manager 230 on the mobile system 200. For example, the tracking module 154 may inquire of the youth whether a service organization was visited as scheduled. The subject manager 230 may provide an emergency help button that transmits a request for help to one or more parties interested in the youth.

Continuing the example above where the subject youth is in possession of the mobile system 200, the subject manager 230 may provide physical tracking of the subject using the location sensor 236. For example, the location sensor 236 may use GPS or another suitable geolocation technology, e.g., geofencing, to determine the location of youth at pre-determined times or at the request of system 100. The subject manager 230 may determine, using the location sensor 236, that the subject has arrived at a service organization, school, or other pre-determined location. The subject manager 230 may transmit the subject's location to the referral controller 106, and the referral controller 106 may use the location information to confirm, and log using the activity manager 150, that the subject visited the assigned service organization, school, or other pre-determined location as scheduled.

As described herein, the subject manager 230 may perform many of the tasks that a human mentor would perform. For example, the subject manager 230 may remind the youth about upcoming appointments using known techniques for delivering alerts to mobile device users. The subject manager 230 may provide transportation coordination. For example, the subject may request a ride to a service organization using the subject manager 230. The subject manager 230 may contact participating transportation companies (e.g., taxi companies, bus companies, etc.) to request a pick-up and may inform the subject that a ride is coming. The subject manager 230 may also cause a ride or transportation voucher to be displayed on, or printed directly and/or indirectly from, the mobile system 200. The ride voucher may entitle the subject to a reduced fare or free ride, and may include a unique identifier, e.g., a voucher number, barcode, or the like.

The subject manager 230 may provide virtual treatment by connecting the subject with a counselor or mentor via text message, instant messaging, phone call, audio chat, and/or video chat. Accordingly, the mobile system 200 may provide text, audio, and/or video communication with remote systems. Alternatively, or additionally, the subject manager 230 may provide virtual treatment by providing an interactive interface that asks questions about the issues the subject is facing and provides relevant information, e.g., methods to deal with the issues.

The translation manager 242, in combination with the at least one audio transducer 240, may facilitate the translation of one natural language to another. Continuing the example above, the police officer and the youth's parents may not speak the same language. In order to facilitate communication between the police officer and the parents, the translation manager 242 may collect audio input in a first language using the transducer 240, e.g., a microphone, and transform the collected audio to either or both written and audible output that is in a second language. For example, the police officer may speak in English, and the translation manager 242 may output, using the transducer 240, e.g., a speaker, a spoken translation of the officer's English speech into Spanish speech.

The methods and systems described herein provide efficient and cost-effective solutions for coordinating youth and family services referrals. Some of the benefits of the methods and systems described herein include fast referral of subjects to appropriate service organizations, sharing of information between interested parties, and, generally speaking, the gaps between government agencies and community resources being bridged to facilitate fewer youths, parents, and others falling through the cracks. The tracking and coordination of treatment may increase the effectiveness of existing community resources and may result in significant cost savings to communities—both in the short-term as a result of increased efficiencies and in the long-term as a result of reduced numbers of at-risk youth and unadopted foster children, among others.

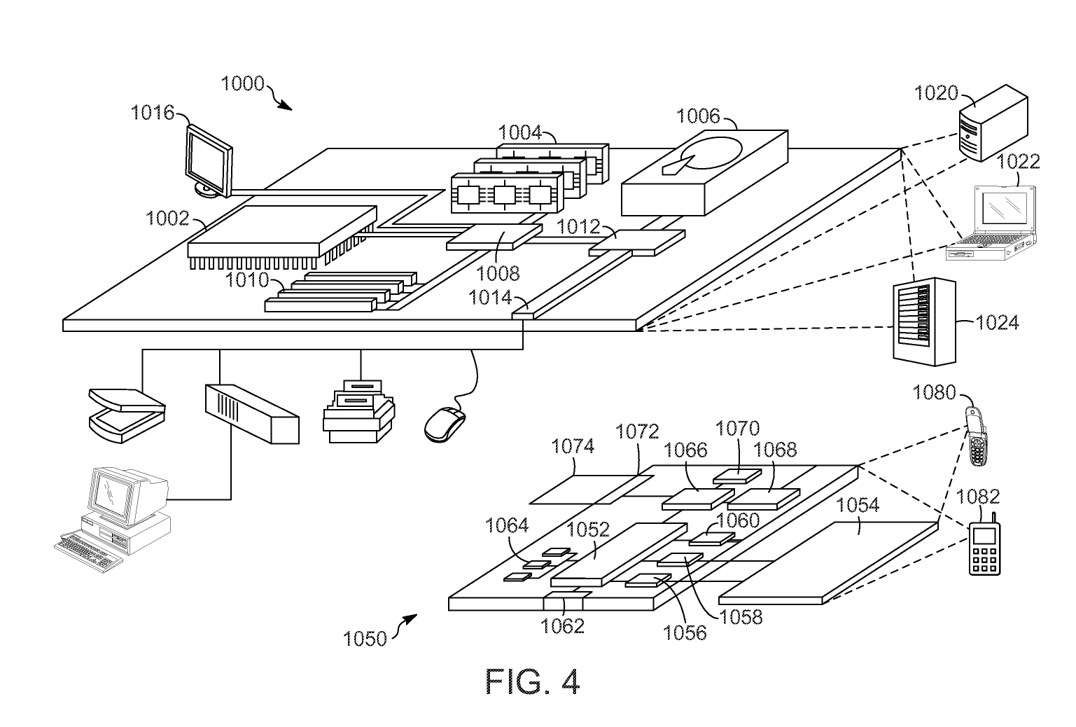

FIG. 4 is a block diagram showing example or representative computing devices and associated elements that may be used to implement the systems of FIGS. 1, 2, and 3. FIG. 4 shows an example of a generic computing device 1000 and a generic mobile computing device 1050, which may be used with the techniques described here. Computing device 1000 is intended to represent various forms of digital computers, such as laptops, desktops, workstations, personal digital assistants, servers, blade servers, mainframes, and other appropriate computers. Computing device 1050 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 1000 includes a processor 1002, memory 1004, a storage device 1006, a high-speed interface or controller 1008 connecting to memory 1004 and high-speed expansion ports 1010, and a low-speed interface or controller 1012 connecting to low-speed bus 1014 and storage device 1006. Each of the components 1002, 1004, 1006, 1008, 1010, and 1012, are interconnected using various busses, and may be mounted on a common motherboard or in other manners as appropriate. The processor 1002 can process instructions for execution within the computing device 1000, including instructions stored in the memory 1004 or on the storage device 1006 to display graphical information for a GUI on an external input/output device, such as display 1016 coupled to high-speed controller 1008. In other implementations, multiple processors and/or multiple buses may be used, as appropriate, along with multiple memories and types of memory. Also, multiple computing devices 1000 may be connected, with each device providing portions of the necessary operations (e.g., as a server bank, a group of blade servers, or a multi-processor system).

The memory 1004 stores information within the computing device 1000. In one implementation, the memory 1004 is a volatile memory unit or units. In another implementation, the memory 1004 is a non-volatile memory unit or units. The memory 1004 may also be another form of computer-readable medium, such as a magnetic or optical disk.

The storage device 1006 is capable of providing mass storage for the computing device 1000. In one implementation, the storage device 1006 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 1004, the storage device 1006, or memory on processor 1002.

The high-speed controller 1008 manages bandwidth-intensive operations for the computing device 1000, while the low-speed controller 1012 manages lower bandwidth-intensive operations. Such allocation of functions is exemplary only. In one implementation, the high-speed controller 1008 is coupled to memory 1004, display 1016 (e.g., through a graphics processor or accelerator), and to high-speed expansion ports 1010, which may accept various expansion cards (not shown). In the implementation, low-speed controller 1012 is coupled to storage device 1006 and low-speed bus 1014. The low-speed bus 1014, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 1000 may be implemented in a number of different forms, as shown in the figure. For example, it may be implemented as a standard server 1020, or multiple times in a group of such servers (e.g., in a server farm or cloud). It may also be implemented as part of a rack server system 1024. In addition, it may be implemented in a personal computer such as a laptop computer 1022. Alternatively, components from computing device 1000 may be combined with other components in a mobile device (not shown), such as device 1050. Each of such devices may contain one or more of computing device 1000, 1050, and an entire system may be made up of multiple computing devices 1000, 1050 communicating with each other.

Computing device 1050 includes a processor 1052, memory 1064, an input/output device such as a display 1054, a communication interface 1066, and a transceiver 1068, among other components. The device 1050 may also be provided with a storage device, such as a microdrive or other device, to provide additional storage. Each of the components 1050, 1052, 1064, 1054, 1066, and 1068, are interconnected using various buses, and several of the components may be mounted on a common motherboard or in other manners as appropriate.

The processor 1052 can execute instructions within the computing device 1050, including instructions stored in the memory 1064. The processor may be implemented as a chipset of chips that include separate and multiple analog and digital processors. The processor may provide, for example, for coordination of the other components of the device 1050, such as control of user interfaces, applications run by device 1050, and wireless communication by device 1050.

Processor 1052 may communicate with a user through control interface 1058 and display interface 1056 coupled to a display 1054. The display 1054 may be, for example, a TFT LCD (Thin-Film-Transistor Liquid Crystal Display) or an OLED (Organic Light Emitting Diode) display, or other appropriate display technology. The display interface 1056 may comprise appropriate circuitry for driving the display 1054 to present graphical and other information to a user. The control interface 1058 may receive commands from a user and convert them for submission to the processor 1052. In addition, an external interface 1062 may be provide in communication with processor 1052, so as to enable near area communication of device 1050 with other devices. External interface 1062 may provide, for example, for wired communication in some implementations, or for wireless communication in other implementations, and multiple interfaces may also be used.

The memory 1064 stores information within the computing device 1050. The memory 1064 can be implemented as one or more of a computer-readable medium or media, a volatile memory unit or units, or a non-volatile memory unit or units. Expansion memory 1074 may also be provided and connected to device 1050 through expansion interface 1072, which may include, for example, a SIMM (Single In Line Memory Module) card interface. Such expansion memory 1074 may provide extra storage space for device 1050, or may also store applications or other information for device 550. Specifically, expansion memory 1074 may include instructions to carry out or supplement the processes described above, and may include secure information also. Thus, for example, expansion memory 1074 may be provide as a security module for device 1050, and may be programmed with instructions that permit secure use of device 1050. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1064, expansion memory 1074, or memory on processor 1052, that may be received, for example, over transceiver 1068 or external interface 1062.

Device 1050 may communicate wirelessly through communication interface 1066, which may include digital signal processing circuitry where necessary. Communication interface 1066 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1068. In addition, short-range communication may occur, such as using a Bluetooth, WiFi, or other such transceiver (not shown). In addition, GPS (Global Positioning system) receiver module 1070 may provide additional navigation- and location-related wireless data to device 1050, which may be used as appropriate by applications running on device 1050.

Device 1050 may also communicate audibly using audio codec 1060, which may receive spoken information from a user and convert it to usable digital information. Audio codec 1060 may likewise generate audible sound for a user, such as through a speaker, e.g., in a handset of device 1050. Such sound may include sound from voice telephone calls, may include recorded sound (e.g., voice messages, music files, etc.) and may also include sound generated by applications operating on device 1050.

The computing device 1050 may be implemented in a number of different forms, as shown in the figure. For example, it may be implemented as a cellular telephone 1080. It may also be implemented as part of a smart phone 1082, personal digital assistant, a computer tablet, or other similar mobile device.

Thus, various implementations of the systems and techniques described here can be realized in digital electronic circuitry, integrated circuitry, specially designed ASICs (application specific integrated circuits), computer hardware, firmware, software, and/or combinations thereof These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system (e.g., computing device 1000 and/or 1050) that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In the example embodiment, computing devices 1000 and 1050 are configured to receive and/or retrieve electronic documents from various other computing devices connected to computing devices 1000 and 1050 through a communication network, and store these electronic documents within at least one of memory 1004, storage device 1006, and memory 1064. Computing devices 1000 and 1050 are further configured to manage and organize these electronic documents within at least one of memory 1004, storage device 1006, and memory 1064 using the techniques described herein.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It will be appreciated that the above embodiments that have been described in particular detail are merely example or possible embodiments, and that there are many other combinations, additions, or alternatives that may be included.

Also, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present features in terms of algorithms and symbolic representations of operations on information. These algorithmic descriptions and representations may be used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or “providing” or the like, refer to the action and processes of a computer system, or similar electronic computing device, that manipulates and transforms data represented as physical (electronic) quantities within the computer system memories or registers or other such information storage, transmission or display devices.

Based on the foregoing specification, the above-discussed embodiments of the invention may be implemented using computer programming or engineering techniques including computer software, firmware, hardware or any combination or subset thereof Any such resulting program, having computer-readable and/or computer-executable instructions, may be embodied or provided within one or more computer-readable media, thereby making a computer program product, i.e., an article of manufacture, according to the discussed embodiments of the invention. The computer readable media may be, for instance, a fixed (hard) drive, diskette, optical disk, magnetic tape, semiconductor memory such as read-only memory (ROM) or flash memory, etc., or any transmitting/receiving medium such as the Internet or other communication network or link. The article of manufacture containing the computer code may be made and/or used by executing the instructions directly from one medium, by copying the code from one medium to another medium, or by transmitting the code over a network.

While the disclosure has been described in terms of various specific embodiments, it will be recognized that the disclosure can be practiced with modification within the spirit and scope of the claims.

What is claimed is:

1. A computer-implemented method including executing instructions stored on a computer-readable medium, the method comprising:
receiving identification information of a subject;
receiving profile information about the subject;
determining, via a processor, at least one service organization based on the identification information and the profile information; and
transmitting information about the at least one service organization.

2. A method in accordance with claim 1, further comprising:
determining, via a processor, at least one mentor based on the identification information and the profile information; and
transmitting information about the subject to the at least one mentor.

3. A method in accordance with claim 2, wherein transmitting information about the at least one service organization comprises transmitting information about the at least one service organization to the at least one mentor.

4. A method in accordance with claim 1, wherein transmitting information about the at least one service organization comprises transmitting at least one of a name, location, and operating hours.

5. A method in accordance with claim 1, wherein receiving identification information of a subject comprises receiving at least one of a name, an address, and a date of birth.

6. A method in accordance with claim 1, wherein receiving identification information of a subject comprises receiving at least one of a facial photo, a voice recording, and a fingerprint.

7. A method in accordance with claim 1, wherein receiving profile information about the subject comprises receiving at least one of a risk factor demonstrated by the subject and an interest expressed by the subject.

8. A method in accordance with claim 1, wherein determining, via a processor, at least one service organization based on the identification information and the profile information further comprises determining, via the processor, at least one service organization based on a current capacity of the at least one service organization.

9. A computer-readable medium having computer-executable instructions embodied thereon, the computer-executable instructions executed on a computing device to instruct the computing device to:
receive identification information of a subject;
receive profile information about the subject;
determine, via a processor, at least one service organization based on the identification information and the profile information; and
transmit information about the at least one service organization.

10. A computer-readable medium in accordance with claim 9, further comprising:
determining, via a processor, at least one mentor based on the identification information and the profile information; and
transmitting information about the subject to the at least one mentor.

11. A computer-readable medium in accordance with claim 10, wherein transmitting information about the at least one service organization comprises transmitting information about the at least one service organization to the at least one mentor.

12. A computer-readable medium in accordance with claim 9, wherein transmitting information about the at least one service organization comprises transmitting at least one of a name, location, and operating hours.

13. A computer-readable medium in accordance with claim 9, wherein receiving identification information of a subject comprises receiving at least one of a name, an address, and a date of birth.

14. A computer-readable medium in accordance with claim 9, wherein receiving identification information of a subject comprises receiving at least one of a facial photo, a voice recording, and a fingerprint.

15. A computer-readable medium in accordance with claim 9, wherein receiving profile information about the subject comprises receiving at least one of a risk factor demonstrated by the subject and an interest expressed by the subject.

16. A computer system including instructions stored on a computer-readable medium and executable by at least one processor, the computer system comprising:
an identification manager configured to receive a subject identifier of a subject and a profile information about the subject;
a service organization manager configured to determine, using the at least one processor, at least one service organization based on the subject identifier and the profile information; and
an activity manager configured to transmit information about the at least one service organization.

17. A computer system in accordance with claim 16, wherein the identification manager is further configured to receive the subject identifier of the subject and the profile information about the subject from a mobile system, the mobile system comprising at least one computing device.

18. A computer system in accordance with claim 17, wherein the mobile system comprises a subject manager configured to transmit location information from a location sensor to the computer system.

19. A computer system in accordance with claim 18, wherein the subject manager is further configured to provide a transportation voucher.

20. A computer system in accordance with claim 18, wherein the subject manager is further configured to provide virtual treatment.
